(19) United States
(12) Patent Application Publication
(10) Pub. No.: US 2007/0070105 A1
(43) Pub. Date: Mar. 29, 2007

(54) METHODS AND APPARATUS FOR ADJUSTING PIXEL FILL PROFILES

(76) Inventors: LIZHONG SUN, San Jose, CA (US); QUANYUAN SHANG, Saratoga, CA (US); JOHN M. WHITE, Hayward, CA (US)

Correspondence Address: DUGAN & DUGAN, PC, 55 SOUTH BROADWAY, TARRYTOWN, NY, 10591, US

(21) Appl. No.: 11/536,540

(22) Filed: Sep. 28, 2006

Related U.S. Application Data
(60) Provisional application No. 60/721,624, filed on Sep. 29, 2005.

(51) Int. Cl. B41J 29/38

(52) U.S. Cl. 347/12; 347/29; 438/935

(57) ABSTRACT

For use in a color filter inkjet printing system that may be part of a flat panel display manufacturing system, methods and apparatus for adjusting a pixel fill profile are provided. The methods include application of, and the apparatus are adapted to apply, pressurized gas to at least one ink-filled pixel well on a substrate having a plurality of pixel wells. Numerous other aspects are provided.

The present application claims priority to commonly-assigned, co-pending U.S. Provisional Patent Application Ser. No. 60/721,624, filed Sep. 29, 2005 and entitled “METHODS AND APPARATUS FOR ADJUSTING PIXEL FILL PROFILES” (Attorney Docket No. 10448/L), which is hereby incorporated herein by reference in its entirety for all purposes.

### CROSS-REFERENCE TO RELATED APPLICATIONS

The present application is related to the following commonly-assigned, co-pending U.S. Patent Applications, each of which is hereby incorporated herein by reference in its entirety for all purposes:

U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING”;

U.S. patent application Ser. No. 11/019,967, filed Dec. 22, 2004 and entitled “APPARATUS AND METHODS OF AN INKJET HEAD SUPPORT HAVING AN INKJET HEAD CAPABLE OF INDEPENDENT LATERAL MOVEMENT” (Attorney Docket No. 9521-1);

U.S. patent application Ser. No. 11/019,929, filed Dec. 22, 2004 and titled “METHODS AND APPARATUS FOR INKJET PRINTING.” (Attorney Docket No. 9521-2);

U.S. patent application Ser. No. 11/019,930, filed Dec. 22, 2004 and entitled “METHODS AND APPARATUS FOR ALIGNING PRINT HEADS” (Attorney Docket No. 9521-3);

U.S. Provisional Patent Application Ser. No. 60/703,146, filed Jul. 28, 2005 and entitled “METHODS AND APPARATUS FOR SIMULTANEOUS INKJET PRINTING AND DEFECT INSPECTION” (Attorney Docket No. 9521-L02(formerly 9521-7/L)); and

U.S. patent application Ser. No. 11/493,861, filed Jul. 25, 2006 and titled “METHODS AND APPARATUS FOR CONCURRENT INKJET PRINTING AND DEFECT INSPECTION.” (Attorney Docket No. 9521-10);

### FIELD OF THE INVENTION

The present invention relates generally to inkjet printing systems employed during flat panel display formation, and is more particularly concerned with apparatus and methods for adjusting the profile of ink deposited in pixel wells.

### BACKGROUND

The flat panel display industry has been attempting to employ inkjet printing to manufacture display devices, and in particular, color filters for flat panel displays. The pixel wells in the color filters are filled by liquid ink. Phenomena known as ink-philicity and ink-phobicity may be associated with a combination of the ink and the substrate material including the pixel matrix material. Such phenomena may cause a pixel fill profile to have undesirable properties such as being unevenly distributed. However, it may not be desirable to change the combination of the ink and substrate material to reduce or eliminate the undesirable properties. Accordingly, there is a need for apparatus and methods for adjusting pixel fill profiles.

### SUMMARY OF THE INVENTION

In some aspects of the invention, a method of adjusting a pixel fill profile is provided. The method includes applying pressurized gas to at least one pixel well having ink with a profile on a substrate having a plurality of pixel wells.

In a additional aspects of the invention, an apparatus for adjusting a pixel fill profile is provided. The apparatus includes a pressurized gas delivery system adapted to direct pressurized gas to at least one pixel well with ink in a substrate having a plurality of pixel wells to adjust a profile of the ink.

In yet other aspects of the invention, a system for adjusting a pixel fill profile is provided. The system includes (1) an inkjet printing system adapted to hold a substrate having a plurality of pixel wells and adapted to deposit ink into at least one of the pixel wells; and (2) a gas delivery system coupled to the inkjet printing system and adapted to direct a pressurized gas to the at least one of the pixel wells.

Other features and aspects of the present invention will become more fully apparent from the following detailed description, the appended claims and the accompanying drawings.

### BRIEF DESCRIPTION OF THE DRAWINGS

FIG. 1 depicts a continuum of wetability 100.

FIGS. 2A and 2B depicts a top schematic view and a perspective view, respectively, of an inkjet printing system according to the present invention.

FIG. 3 depicts a close-up view of an exemplary embodiment of a print head portion of an inkjet printing system according to the present invention.

FIG. 4 is a perspective view of an exemplary matrix of pixel wells in a substrate of a color filter.

FIG. 5 depicts a first exemplary profile graph of the ink within the filled pixel wells taken as a cross-section along the 4-4 line in FIG. 4.

FIG. 6 depicts a second exemplary profile graph of the ink within one of the filled pixel wells and the four pixel wells taken as a cross-section along the 5-5 line in FIG. 4.

FIG. 7 depicts a perspective view of the exemplary matrix of pixel wells in a substrate of a color filter after the methods of the present invention have been applied to adjust the ink in the filled pixel wells.

FIG. 8 depicts a third exemplary profile graph of the adjusted ink within the adjusted filled pixel wells taken as a cross-section along the 7-7 line in FIG. 7.

FIG. 9 depicts a fourth exemplary profile graph of the adjusted ink within one of the filled pixel wells and the four pixel wells taken as a cross-section along the 8-8 line in FIG. 7.

### DETAILED DESCRIPTION

Flat panel display manufacturing may use color filters that include different colored inks printed on a glass (or other material) substrate. The ink may be deposited using an inkjet printer system adapted to precisely jet ink and/or other suitable material directly into specific pixel wells defined by a matrix. Before the ink is deposited, the matrix of pixel wells may be formed on the on the substrate using lithography or any suitable process. Due to variations in the ink-philicity/ink-phobicity of the substrate and/or the material used to form the matrix, the cross-sectional profile (e.g., the distribution) of the ink drops deposited into the pixel wells may not be optimal for forming color filters. In some cases, the uneven distribution of ink within a pixel well may result in a defect in the color filter. For example, if the ink “beads-up,” it may not fill the pixel wells completely. In another example, if the side walls are ink-philic and a pixel well is not completely filled, a concave (e.g., meniscus) profile may result. The inventors of the present invention have noticed that the ink-philicity/ink-phobicity of the matrix varies significantly among manufactures. Attempts to adjust the surface tension and thus, fill profile of the ink through chemical variations, if even possible, may not be satisfactory.

The present invention provides methods and apparatus for adjusting the distribution of ink (or other material) within pixel wells, regardless of the ink-philicity/ink-phobicity of the substrate and/or the material used to form the matrix, so that the resulting cross-sectional profile if the deposited ink conforms to a desired shape. For example, a slightly crowned profile or a flat profile may be desired for a color filter application. According to embodiments of the present invention, a stream or curtain of pressurized gas may be used to push ink previously deposited in pixel wells to conform to a desired profile. The pressurized gas may include nitrogen and/or any suitable non-reactive gas. The pressurized gas may be applied immediately after the deposition of the ink or up until the ink cures. In some embodiments, one or more nozzles for directing the pressurized gas may be mounted to a support member that also supports inkjet print heads. As the print heads pass over a substrate depositing ink into pixel wells, the pressurized gas may be directed at the ink just deposited to adjust the profile of the ink.

In alternative or additional embodiments, rather than dynamically applying pressurized gas to the pixel wells as they are filled, the entire substrate may be placed in a chamber within which an overall increased air/gas pressure may be applied to all pixel wells. The increased air/gas pressure acts to adjust the distribution of ink within the pixel wells.

In some embodiments, the substrate, gas, and or ink may additionally be heated to further aid in adjusting the distribution of ink within the pixel wells. Heat may affect the fluidity and/or surface tension of the materials and thus, alter the ink's profile within the pixel wells.

The present invention provides for a number of advantages. For example, the present invention can be utilized to concurrently deposit inks and adjust the profiles of the deposited inks. By adjusting the profile of the deposited inks, the occurrence of defects resulting from uneven distribution of ink may be reduced or eliminated. Further, through timing and the use of different amounts of gas pressure, the amount of force applied to the deposited ink may be controlled to adjust the shape of the ink's profile within the pixel wells.

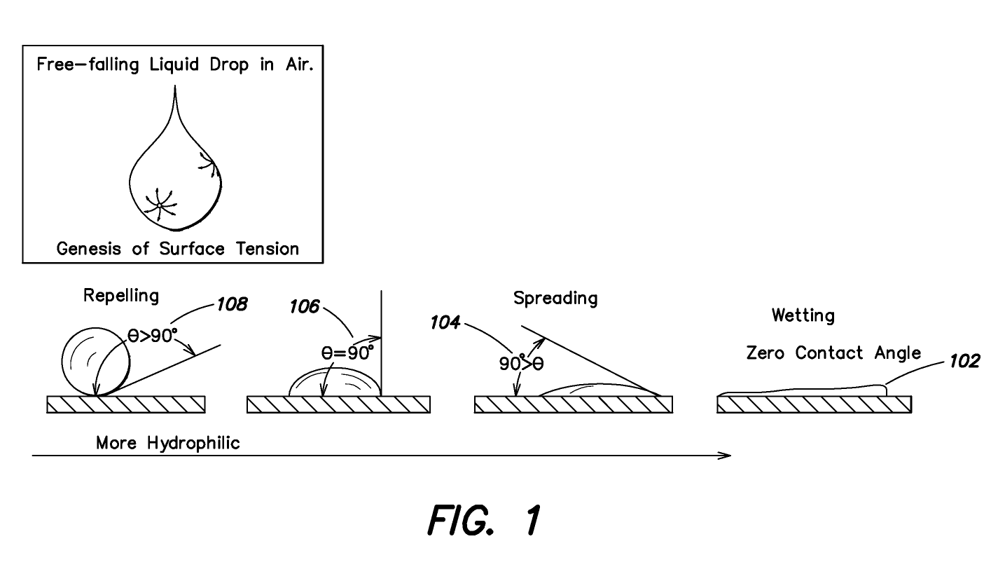

Turning to FIG. 1, a continuum of wetability 100 is depicted. For a given droplet A on a solid surface B the contact angle θ is a measurement of the angle formed between the surface of a solid B and the line tangent to the droplet A radius from the point of contact with the solid B. The contact angle θ is related to the surface tension by Young's equation through which the behavior of specific liquid-solid interactions can be calculated. A contact angle θ of zero degrees 102 results in wetting, while an angle θ between zero and ninety degrees 104 results in spreading of the drop (due to molecular attraction). A contact angle θ of ninety degrees 106 may result in steady state in which the surface tension stops the spreading of the liquid. Angles θ greater than ninety degrees 108 indicate that the liquid tends to bead or shrink away from the solid surface.

Flat panel display manufacturing may use color filters that include different colored inks printed on a glass (or other material) substrate. The ink may be deposited using an inkjet printer adapted to precisely jet ink and/or other suitable material directly into specific pixel wells defined by a matrix. Before the ink is deposited, the matrix of pixel wells may be formed on the on the substrate using lithography, printing, or any other suitable process. Due to variations in the ink-philicity/ink-phobicity of the substrate and/or the material used to form the matrix, the cross-sectional fill profile (e.g., the distribution) of the ink drops deposited into the pixel wells may not be optimal for forming color filters. In some cases, the uneven distribution of ink within a pixel well may result in a defect in the color filter. For example, if the ink “beads-up,” it may not fill the pixel wells completely. The inventors of the present invention have noticed that the ink-philicity/ink-phobicity of the matrix varies significantly among manufactures. Attempts to adjust the surface tension and thus, the fill profile of the ink through chemical variations, if even possible, may not be satisfactory.

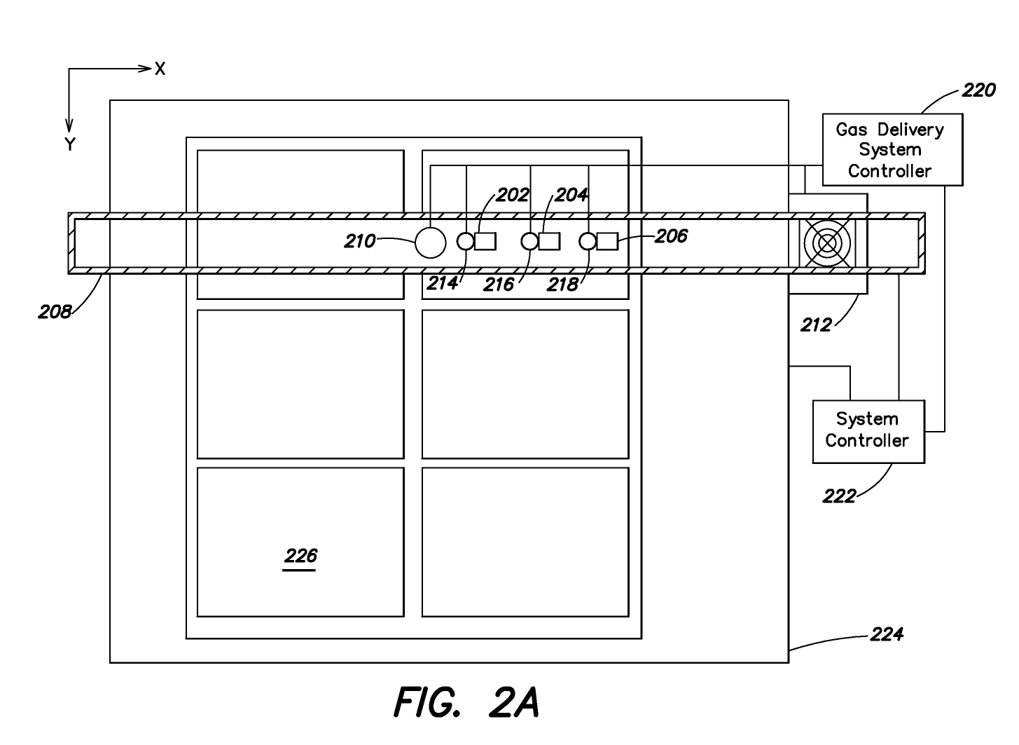

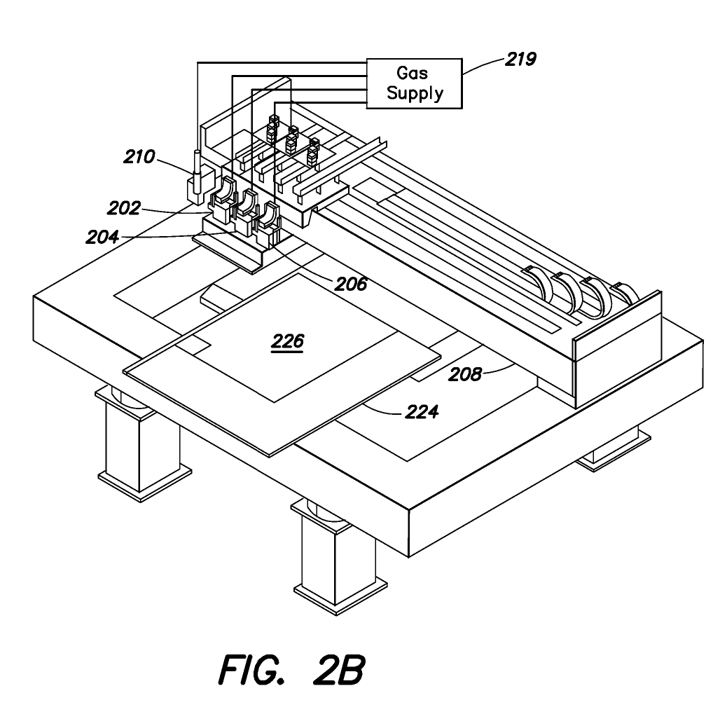

Turning to FIGS. 2A and 2B, a top schematic view and a perspective view, respectively, of an inkjet printing system 200 according to the present invention are depicted. The inkjet printing system 200 of the present invention, in an exemplary embodiment, may include print heads 202, 204, 206. Print heads 202, 204, 206 may be supported on a print bridge 208. Print bridge 208 may also support pressurized gas delivery systems 210 and/or 212 and/or 214, 216, and 218. Pressurized gas delivery systems 210-218 may be coupled to a gas supply 219 (FIG. 2B) and a pressurized gas delivery system controller 220 (FIG. 2A). The pressurized gas delivery system controller 220 may be logically (e.g., electrically, wirelessly, optically, etc.) and/or mechanically coupled to the pressurized gas delivery systems 210-218. Similarly, print heads 202-206 and print bridge 208 may be coupled to a system controller 222. The system controller 222 may be logically (e.g., electrically) and/or mechanically coupled to the print heads 202-206 and print bridge 208. In some embodiments, the pressurized gas delivery system controller 220 may be directly coupled to, in communication with, and/or under the control of the system controller 222. In additional or alternative embodiments, the pressurized gas delivery system controller 220 and the system controller 222 may be one in the same. The inkjet printing system 200 may also include a stage 224 which may support a substrate 226.

In the exemplary embodiments of FIGS. 2A and 2B, the print bridge 208 may support the print heads 202-206. Although three print heads 202-206 are shown on print bridge 208 in FIGS. 2A and 2B, it is important to note that any number of the print heads 202-206 may be mounted on and/or used in connection with the print bridge 208 (e.g., 1, 2, 4, 5, 6, 7, etc. print heads). The print heads 202-206 may be capable of dispensing a single color of ink or, in some embodiments, may be capable of dispensing multiple colors of ink.

In operation, the pressurized gas delivery systems 210-218 may apply gas pressure to the pixel wells in a scanning process that coincides with the printing process. Alternatively or additionally, the scanning process may be performed after printing has completed. In some embodiments, the scanning process may be performed perpendicular to the printing direction while in other embodiments, the scanning may be in the printing direction. Although not shown, the substrate (and the inkjet printing system 200) may be enclosed in a chamber adapted to contain pressurized gas/air. In some embodiments, the chamber may be adapted to heat the substrate. The scanning process may be performed under fixed or variable heat and pressure recipes within the chamber.

The inkjet printing system 200 of the present invention may include any number of pressurized gas delivery systems 210-218 (e.g., 1, 2, 3, 4, 5, 6, etc.) or it may include a single system coupled to any number of nozzles. Exemplary pressurized gas delivery systems suitable for use with an inkjet print system 200 according to the present invention include the Continuous Gas System available from Praxair Corporation.

The pressurized gas delivery systems 210-218 may include one or more plenums having an opening or be coupled to an array of nozzles adapted to dispense a curtain of pressurized gas onto a substrate. The opening or nozzles may be round, rectangular, or any suitable shape. For example, the curtain of pressurized gas may by formed by releasing the gas through a rectangular slit in a plenum. In some embodiments, the pressure of the gas may be controlled at the gas supply 219 and/or by adjusting the opening of the pressurized gas delivery systems 210-218. The pressure of the gas may be varied depending upon the desired profile of the ink in the pixel well. A profile suitable for use in manufacturing color filters for displays may be achieved using gas pressures in the range of 5 to 150 PSI. However, other pressures may be used. The opening(s) through which pressurized gas is released upon the substrate may be located from approximately 2 mm to approximately 10 mm above the substrate. Other distances between the opening and the substrate may be used.

In a first exemplary embodiment, the pressurized gas delivery system 210 may be coupled to the print bridge 208 in a position and manner similar to that used for a print head. That is, the pressurized gas delivery system 210 may be capable of similar rotation and movement as the print heads 202-206 and may be moved adjacent the print heads 202-206 or may be spaced apart from them. The pressurized gas delivery system 210 may coupled to a single nozzle or, in some embodiments, nozzles (e.g., 2, 3, 4, . . . , 200, 101, etc.) in a cluster or array. In some embodiments, the gas delivery system 210 may be adapted to sense the amount of pressure being applied to the ink in the pixel wells and provide a feedback signal to the pressurized gas delivery system controller 220. Pressure, optical, and/or temperature sensors may be included in the pressurized gas delivery system 210 to collect and provide feedback and/or feed-forward data. The pressurized gas delivery system 210 may be positioned on either side of the print heads 202-206 or may be positioned interstitially.

In one or more embodiments, the pressurized gas delivery system 210 may be positioned to the left of the print heads 202-206 (e.g., as shown in FIGS. 2A, 2B, and 2). With the pressurized gas delivery system 210 positioned to the left of the print heads 202-206 and a print pass proceeding from left to right (e.g., ink is deposited into a column of pixel wells on a substrate, followed by the stage shifting to the left in preparation for the next print pass), the pressurized gas delivery system 210 will first adjust the ink profile of the pixel wells just printed. In some embodiments, the pressurized gas delivery system 210 may also be capable of adjusting ink profiles of previous print passes, the most recently printed pass, and/or the current print pass. The pressurized gas delivery system 210 may be positioned to adjust the ink profiles of pixel wells on the substrate located directly beneath the associated nozzle(s) (e.g., adapted to adjust ink profiles of pixel wells printed in previous passes). Alternatively, the pressurized gas delivery system 210 may be angled to adjust the profiles of pixel wells that lie along a print pass in progress or may be angled in any direction to adjust the profiles of pixel wells at various portions of the substrate.

In a second exemplary embodiment, the pressurized gas delivery system 212 of FIG. 2A may be coupled directly to and supported by the print bridge 208. This coupling location may be adjacent the print heads 202-206 or may be located elsewhere on the print bridge 208. The pressurized gas delivery system 212 may be coupled to a single nozzle or, in some embodiments, multiple nozzles arranged in an array.

In a third exemplary embodiment, the pressurized gas delivery systems 214-218 may be attached to and adjacent the print heads 202-206. That is, the pressurized gas delivery system 214 may be separately mounted on the print bridge 208 immediately adjacent the print head 202 or may be mounted to the same assembly as the print head 202 such that any movement by the print head 202 will coincide with (e.g., cause) movement of the pressurized gas delivery system 214. Similarly, the pressurized gas delivery system 216 may be mounted with or adjacent print head 204 and pressurized gas delivery system 218 may be mounted with or adjacent print head 206. Each print head 202-206 may have an associated pressurized gas delivery system 214-216.

In embodiments where each print head 202-206 has a corresponding pressurized gas delivery system 214-218, each pressurized gas delivery system 214-216 may be oriented to apply pressure to a different set of pixel wells. For example, during a printing operation where the printing proceeds from left to right, the pressurized gas delivery system 218 may adjust the ink profiles of a printed column of pixel wells. The pressurized gas delivery system 216 may adjust the ink profiles of two filled columns of pixel wells. The pressurized gas delivery system 214 may adjust the ink profiles of three filled columns.

Alternatively, the pressurized gas delivery systems 214-218 may be coupled to more than one nozzle such that the nozzles are clustered at one or more print heads 202-206 and one or more print heads do not have an associated pressurized gas delivery system 214-218. For example, in some embodiments, print head 202 may have a pressurized gas delivery system 214 mounted along with the print head. The pressurized gas delivery system 214 may be coupled to two or more nozzles, each capable of adjusting ink profiles differently. The print heads 204, 206 may not include a pressurized gas delivery system 216, 218. When two nozzles are coupled to the pressurized gas delivery system 214, one nozzle may supply gas at a first pressure to adjust a first type of ink (or cause a first type of profile) in a first pixel well and one nozzle may supply gas at a second, different pressure to adjust the profile of a second type of ink (or cause a second type of profile) in a second pixel well. Alternatively or additionally, differently pressurized gases dispensed from different nozzles may be used to adjust the profiles of inks at different stages of curing and/or within a single pixel well.

When three nozzles are coupled to the pressurized gas delivery system 214, each nozzle may be capable of adjusting a different portion of an ink profile within a pixel well through the use of differently pressurized gases. For example, pressured gas aimed at either end of a pixel well may be applied at a first pressure while pressurized gas at a second pressure may be applied to a center portion of the pixel well. If the first pressure is higher than the second pressure, a profile having a relatively high center point and lower end points may be achieved. Alternatively, a single nozzle applying pressurized gas at a variable pressure as it moves along the pixel well may be used to achieve a similar profile.

The pressurized gas delivery systems 210-218 may be coupled to the pressurized gas delivery system controller 220 logically (e.g., electrically, wirelessly, optically, etc.) and/or mechanically. The pressurized gas delivery system controller 220 may include software capable of selectively applying pressurized gas to the pixel wells as described above. The pressurized gas delivery controller 220 may be capable of processing and/or storing feedback/feed-forward data received from each pressurized gas delivery system 210-218. The feedback/feed-forward data may indicate the amount of pressure actually being applied to the pixel wells and/or the temperature of the area near the pixel wells. The feedback data may be used to adjust the amount of pressure being applied to the pixel wells.

In alternative embodiments, each pressurized gas delivery system 210-218 may have an associated pressurized gas delivery system controller (e.g., each pressurized gas delivery system 210-218 may be capable of individually responding to feedback/feed-forward data). The feedback/feed-forward data from the pressurized gas delivery systems 210-218 may include location coordinates (e.g., on an XY plane) of the sensed region. The location data may also be retrieved or received from the inkjet printing system (e.g., system controller 222).

The pressurized gas delivery system controller 220 may be any suitable computer or computer system, including, but not limited to, a mainframe computer, a minicomputer, a network computer, a personal computer, and/or any suitable processing device, component, or system. The pressurized gas delivery system controller 220 alternatively may comprise a dedicated logic circuit or any suitable combination of hardware and/or software. The pressurized gas delivery system controller 220 may be adapted to control any of the pressurized gas delivery systems 210-218, including controlling the movement of each pressurized gas delivery system 210-218 rotationally and in both positive and negative lateral displacement directions along the X-axis; the positive X-axis direction being indicated by the frame of reference arrow labeled X in FIG. 2A. Additionally, the pressurized gas delivery system controller 220 may be capable of controlling the angle at which pressurized gas is applied by the pressurized gas delivery systems 210-218 relative to the substrate, the temperature and pressure of the pressurized gas, the distance of the pressurized gas delivery systems 210-218 from the substrate, or perform any other control necessary.

As noted above, the system 200, in an exemplary embodiment, may include the system controller 222. As with the pressurized gas delivery system controller 220, the system controller 222 may be any suitable computer or computer system, including, but not limited to, a mainframe computer, a minicomputer, a network computer, a personal computer, and/or any suitable processing device, component, or system. The system controller 222 alternatively may comprise a dedicated logic circuit or any suitable combination of hardware and/or software. The system controller 222 may be adapted to control any of the print heads 202-206 through the print head support 208, including controlling the movement of each print head 202-206 rotationally and in both positive and negative lateral displacement directions along the X-axis; the positive X-axis direction being indicated by the frame of reference arrow labeled X in FIG. 2A. The system controller 222 may also control any and all inkjet printing and maintenance operations capable of being performed by the print head support 208, and/or the print heads 202-206.

The system controller 222 may interface with the pressurized gas delivery system controller 220 and/or may communicate directly with the pressurized gas delivery systems 210-218. Either the pressurized gas delivery system controller 220 or the system controller 222 may determine adjustments to be made to the pressure and/or temperature of the gas, the orientation or position of the nozzles, and/or the timing of the application of pressurized gas.

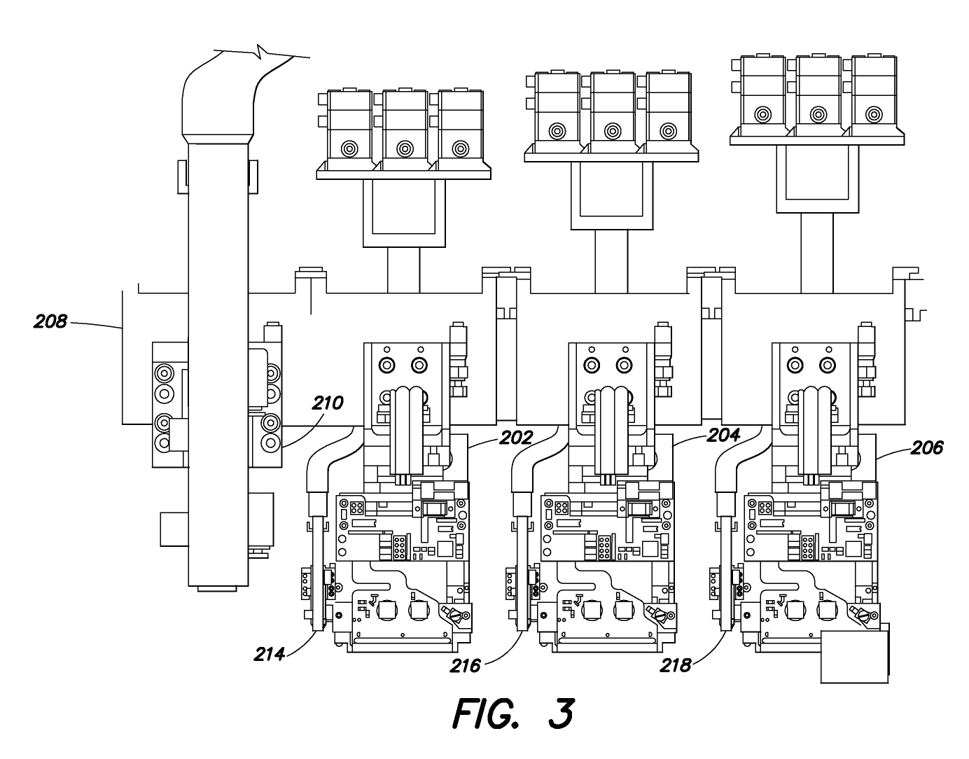

FIG. 3 depicts a close-up view of an exemplary embodiment of a print head portion 200 of an inkjet printing system 200 (FIGS. 2A & 2B) according to the present invention. As indicated above, the print head portion 200 may include print heads 202, 204, and 206 mounted on the print bridge 208. Also mounted on the print bridge 208, in a position and manner similar to those shown in FIGS. 2A and 2B, may be the pressurized gas delivery systems 210, 214, 216, and 218. The pressurized gas delivery system 210 may be movable, rotatable, and angleable in such ways as to allow the system to adjust the ink profile of pixel wells of a current or prior printing pass. In an alternative embodiment, the pressurized gas delivery systems 214-218 may be mountable in the same mount as any of the print heads 202-206 or to the print heads 202-206 themselves and may be similarly movable, rotatable, and angleable. The pressurized gas delivery systems 214-218 may be mounted on any side of the print heads 202-206 to adjust current and prior printed pixel wells. For example, the pressurized gas delivery system 214 mounted to the left of the print head 202 may be capable of adjusting ink profiles of pixel wells in the prior print pass or passes. If the pressurized gas delivery system 214 were mounted on the right side of the print head 202, the pressurized gas delivery system 214 may be capable of adjusting the ink profiles of the pixel wells printed in the prior print pass or passes of the print head 204.

The pressurized gas delivery systems 214-218 may also be mounted fore and/or aft of any of the print heads 202-206 relative to the print direction (which may be both positive and negative directions along the Y-axis, the positive Y-axis direction being indicated by the frame of reference arrow labeled Y in FIG. 2A). In this configuration, the pressurized gas delivery systems 214-218 may be capable of adjusting the ink profiles immediately following the dispensing of ink (thus not having to wait until an entire print pass is completed) regardless of whether the substrate is being moved in the positive or negative Y-axis direction. For example, an aft-mounted gas delivery system may apply pressurized gas when the substrate is moved in the negative Y-axis direction while a fore-mounted gas delivery system may apply pressurized gas when the substrate is moved in the positive Y-axis direction.

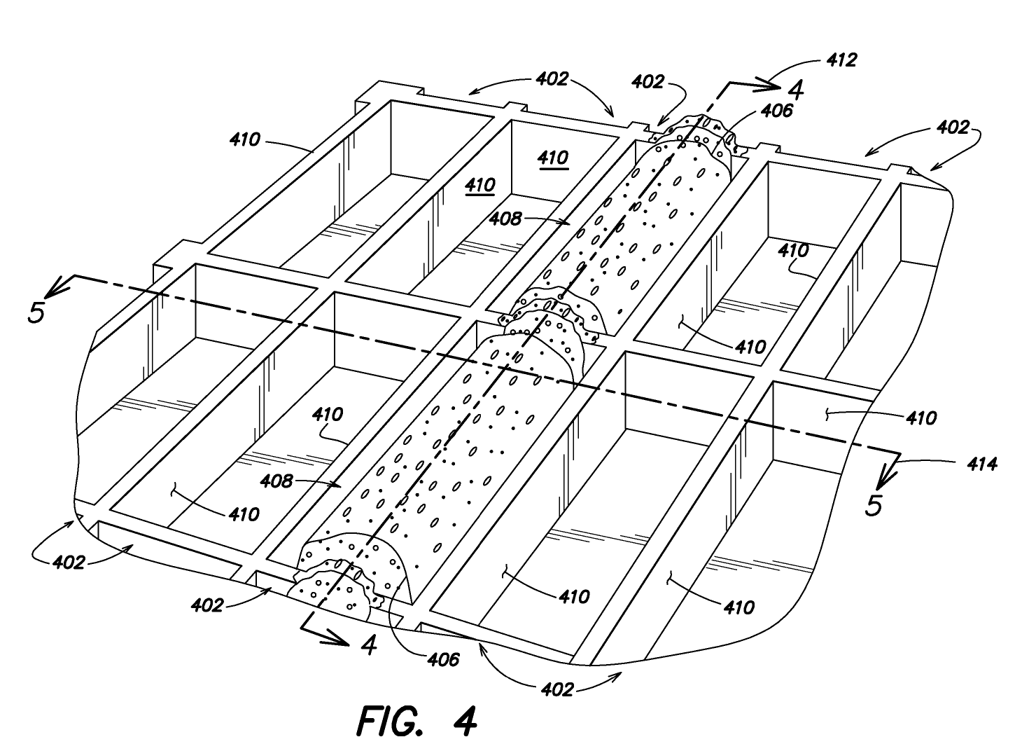

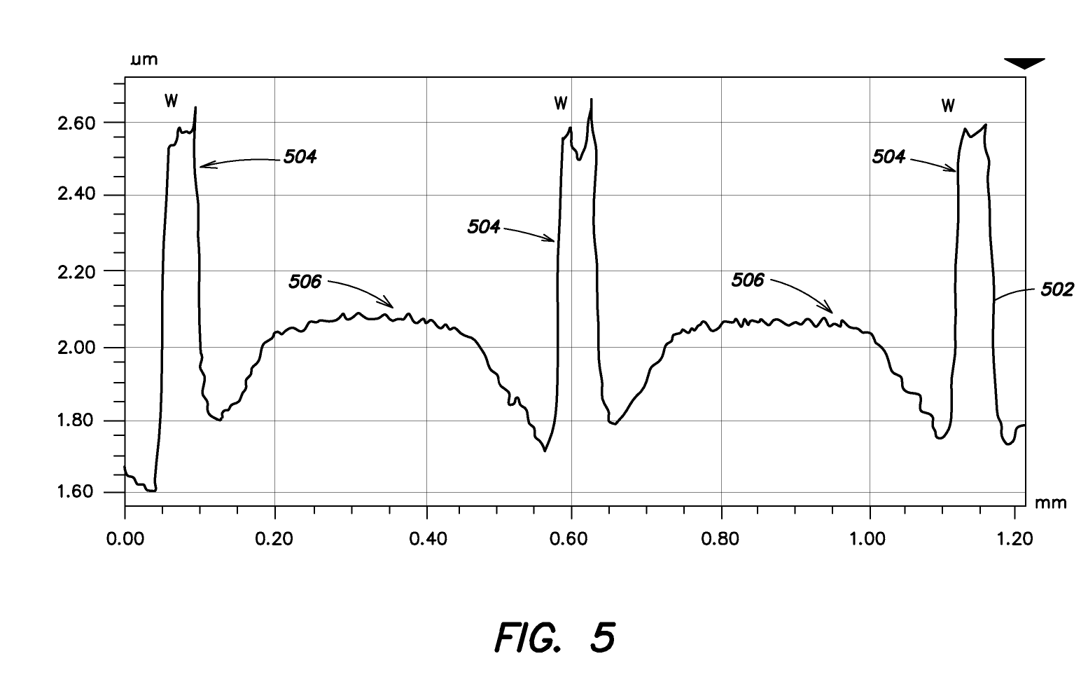

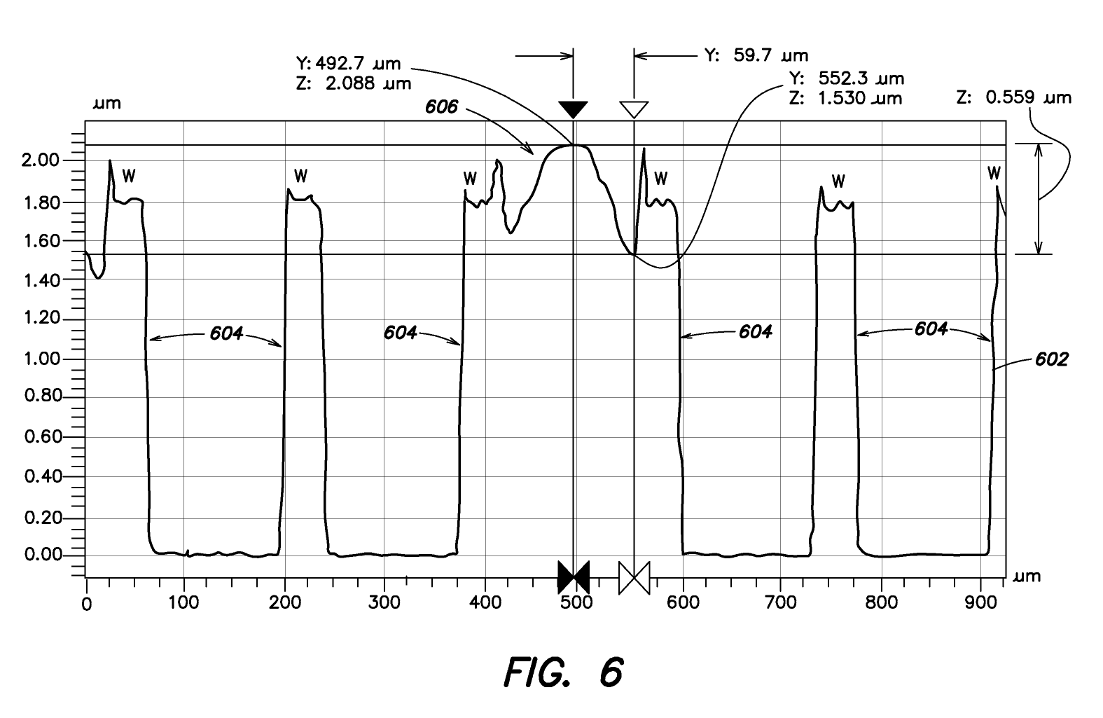

FIG. 4 is a perspective view of an exemplary matrix 400 of pixel wells 402 in a substrate 404 of a color filter. The pixel wells 402 may be formed in a substrate 404 by employing lithography or another suitable method. Some of the pixel wells 402 may be filled with ink 406. As depicted, the matrix 400 has two filled pixel wells 408. The pixel wells 402 may include walls 410 that contain the ink 406. Also depicted in FIG. 4 is a 4-4 line 412 located approximately collinear with a longitudinal axis of the two filled pixel wells 408. In addition, a 5-5 line 414 is depicted approximately perpendicular to the longitudinal axis of the two filled pixel wells 408. The two lines 412 and 414 serve as reference lines for cross section views discussed below with reference to FIGS. 5 and 6. Although FIGS. 4-9 depict an exemplary matrix 400 of pixel wells 402, the present invention may be employed with other embodiments of the matrix 400 of pixel wells 402 used in color filters.

The substrate 404 may be glass or any suitable material with a thickness, for example, ranging from about 0.6 mm to about 0.8 mm. Other substrates with different thicknesses may be used. In a non-limiting example embodiment, the pixel wells 402 may be about 1 μm to about 3 μm deep, about 0.3 mm to about 0.5 mm long, and about 100 μm to about 140 μm wide although any suitable or desired dimensions may be employed. The pixel wells 402 are depicted as arranged in a coplanar and grid manner although any suitable arrangement may be employed. The ink 406 may be an ink for inkjet printing of color filters for flat panel displays that includes one or more organic pigments; one or more monomers; one or more polymeric dispersants; one or more wetting agents; and one or more organic solvents, although any suitable liquid may be employed. As depicted in FIG. 4, the filled pixel wells 408 may be partially filled with the ink 406 and contained by the walls 410. Although four walls 410 are depicted in a rectangular configuration for each of the pixel wells 402, other number (e.g., 3, 5, 6, etc.) of walls 410 and/or configurations (e.g., circular, trapezoidal, triangular) may be employed.

As depicted in FIG. 4, the ink 406 has an undesired profile (e.g., unevenly distributed). Specifically, the profile of the ink 406 is curved with a peak approximately longitudinal with the 4-4 line 412. The profile includes a portion near the walls 410 of the pixel wells 402 that is lower than a top portion of the walls 410. Although the profile is depicted as domed (e.g., convex) in shape, other profiles (e.g., concave, rippled, etc.) may be present in the same or different combinations of ink and substrate materials. The present invention may be employed with the other profiles. Also, note that although two unadjusted filled pixel wells 408 are depicted in FIG. 4, more or fewer (e.g., 1, 3, 4, 5, etc.) filled pixel wells 408 may be adjusted as described above with reference to FIGS. 1-3.

FIG. 5 depicts a first exemplary profile graph 500 of the ink 406 within the filled pixel wells 408 taken as a cross-section along the 4-4 line 412 in FIG. 4. A 4-4 profile line 502 represents the profile of the pixel wells 402, the walls 410, and the filled pixel wells 408. A wall trace 504 of the 4-4 profile line 502 corresponds with the walls 410. Similarly, the ink traces 506 correspond with the ink 406. Note that the ink traces 506 are unevenly distributed (e.g., the top surface has a dome shape) and generally drawn away from wall trace 504 of the 4-4 profile line 502. As depicted by the ink traces 506, the level of ink 406 at the highest (thickest) point is approximately 2.1 micrometers. The level of ink 406 at the lowest (thinnest) point is approximately 1.8 micrometers. Thus, difference between the lowest and highest points is approximately 0.3 micrometers.

FIG. 6 depicts a second exemplary profile graph 600 of the ink 406 within one of the filled pixel wells 408 and the four of the pixel wells 402 taken as a cross-section along the 5-5 line 414. A 5-5 profile line 602 represents the profile of the pixel wells 402, the walls 410, and the filled pixel wells 408. Wall traces 604 of the 5-5 profile line 602 correspond with the walls 410. Similarly, the ink trace 606 corresponds with the ink 406. Note that the ink trace 606 is unevenly distributed (e.g., the top surface has a dome shape) and generally drawn away from wall trace 604 of the 5-5 profile line 602. Similar to first profile graph 500 depicted in FIG. 5, the level of ink at the highest (thickest) point in the second profile graph 600 is approximately 2.1 micrometers. The level of the ink 406 at the lowest (thinnest) point in the second profile graph 600 is approximately 1.5 micrometers. Thus, the difference between the highest and lowest points is approximately 0.6 micrometers.

Thus, the matrix 400 in FIGS. 4 and the associated profile graphs of FIGS. 5 and 6, depict an example of the distribution of the ink 406 as it may typically be disposed after being deposited into pixel wells 402 by an inkjet printing system or another suitable system.

The present invention provides various methods of adjusting (e.g., flattening) undesired profiles after printing. The ink thickness variations can be reduced so that thickness and color uniformity is greatly improved at both the pixel level and the display object level (e.g., the panel level). There are a number of variations of the methods of the present invention that may be employed to achieve a desired ink profile. In a first exemplary variation, printed substrates may be placed into a pressurized chamber with a pressure ranging from approximately 5 to approximately 150 PSI for approximately ten seconds to approximately five minutes. In a second exemplary variation, printed substrates may be placed into a pressurized chamber with a pressure ranging from approximately 5 to approximately 30 PSI using either heated compressed nitrogen (N2) or heated compressed air for approximately ten seconds to approximately five minutes. In either case, the heated gas may be in the range from approximately 40 degrees Celsius to approximately 80 degrees Celsius. However, in either of these first two variations, other temperature, pressure, and time ranges may be used.

In a third exemplary variation of the present methods, substrates may be scanned with a pressurized gas delivery system (e.g., a compressed N2 or compressed air nozzle) at a rate of approximately five feet per minute (e.g., one to ten ft/min), either following the print direction or approximately perpendicular to the print direction, within a heated chamber. The chamber may be heated within the range from approximately 40 degrees Celsius to approximately 80 degrees Celsius. The scanning may be performed concurrently with the printing (e.g., immediately after the ink is deposited) or after printing has been completed entirely or partially. The pressurized gas may be in the range of approximately five to approximately forty PSI. However, other chamber temperatures, scan rates, directions, pressures, time frames, and gases may be used.

In a fourth exemplary variation of the present methods, substrates may be scanned with a heated, pressurized gas delivery system (e.g., a heated compressed N2 or heated compressed air nozzle) at a rate of approximately five feet per minute (e.g., one to ten ft/min) following the print direction or approximately perpendicular to the print direction. The scanning may be performed concurrently with the printing (e.g., immediately after the ink is deposited) or after printing has been completed entirely or partially. The pressurized gas may be in the range of approximately five to approximately forty PSI. The temperature of the gas may be in the range from approximately 40 degrees Celsius to approximately 80 degrees Celsius. However, other gas temperature ranges, scan rates, directions, pressures, time frames, and gases may be used.

In alternative or additional embodiments, the substrates may be heated. The stage upon which the substrate is supported may include heating elements controlled by either the pressurized gas delivery system controller 220 or the system controller 222. Alternatively, a spot heater coupled to the print bridge may be employed. For example, the substrates may be heated to a temperature of approximately 40 degrees Celsius to approximately 80 degrees Celsius. Other temperatures may be used.

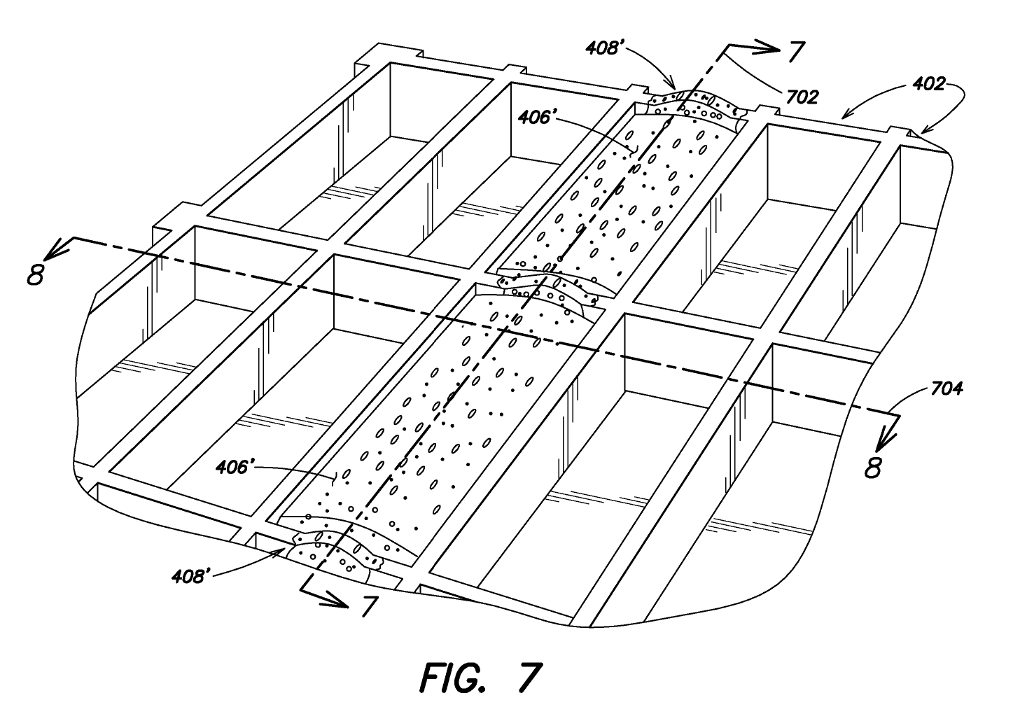

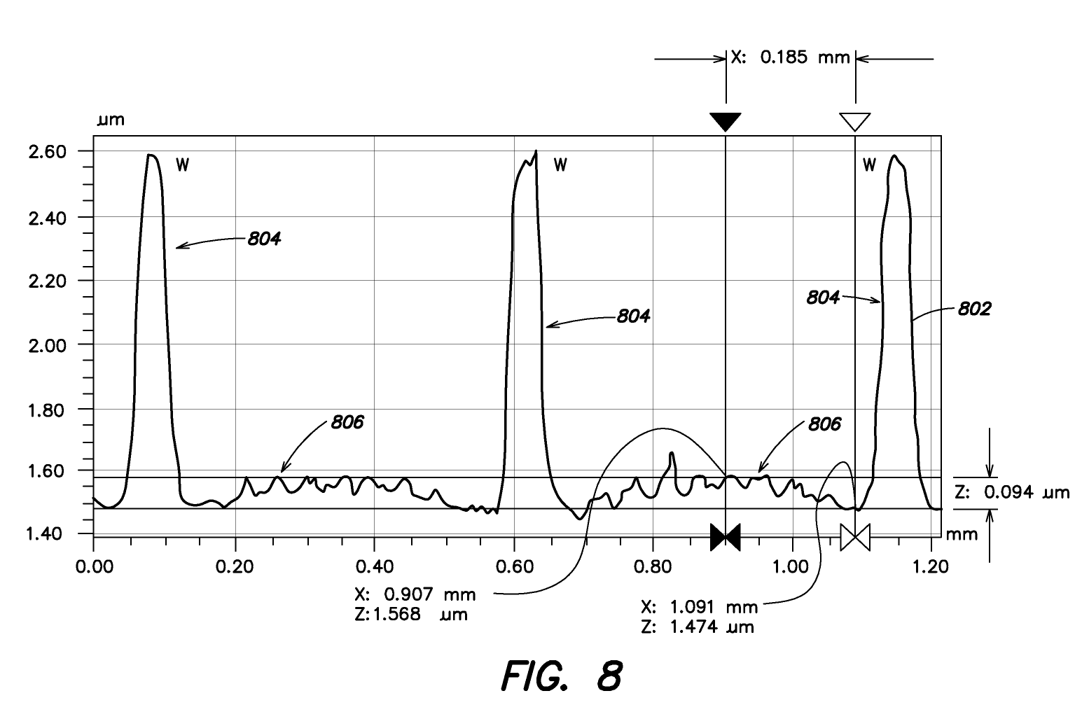

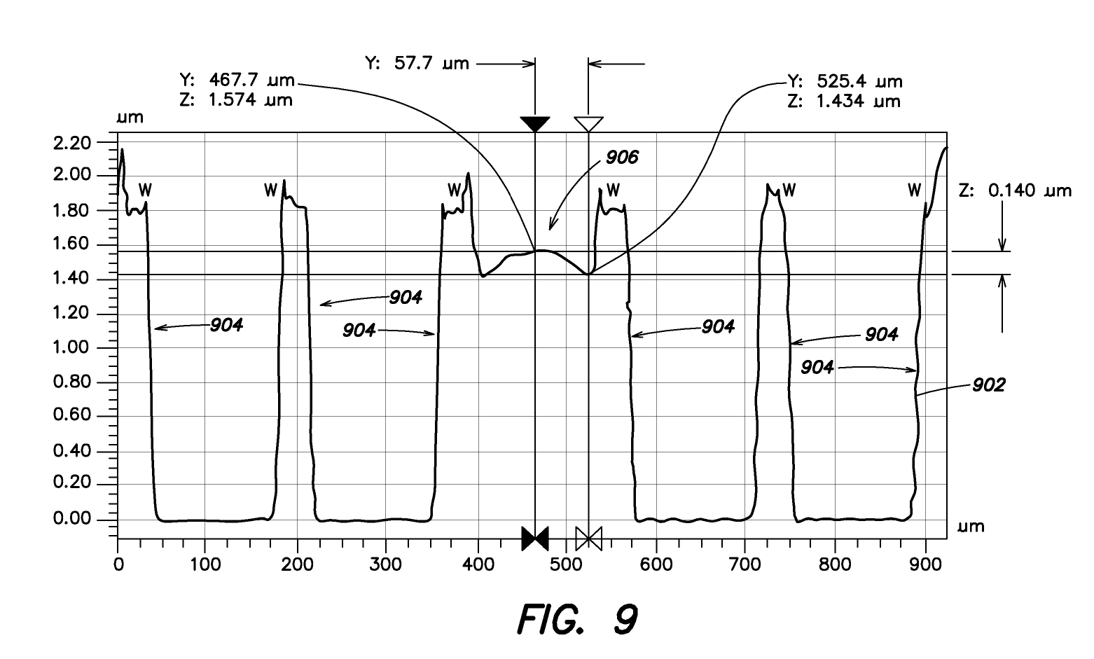

Turning to FIG. 7, a perspective view of the exemplary matrix 400 of pixel wells 402 in a substrate 404 of a color filter after the methods of the present invention have been applied to adjust the ink 406 in the filled pixel wells 408 is depicted. According to the present invention, as described above, pressurized gas is used to adjust the distribution of the ink 406 within the pixel wells 402. As depicted in FIG. 7, the adjusted ink 406′ in the adjusted filled pixel wells 408′ have profiles that are more desirably distributed (e.g., evenly) than the ink 406 depicted in FIG. 4, as will be described in more detail below with reference to FIGS. 8 and 9. Also depicted in FIG. 7 is a 7-7 line 702 located approximately collinear with a longitudinal axis of the two adjusted filled pixel wells 408′. In addition, an 8-8 line 704 is depicted approximately perpendicular to the longitudinal axis of the two filled pixel wells 408′. The two lines 702 and 704 serve as reference lines for cross section views discussed below with reference to FIGS. 8 and 9.

FIG. 8 depicts a third exemplary profile graph 800 of the adjusted ink 406′ within the adjusted filled pixel wells 408′ taken as a cross-section along the 7-7 line 702 in FIG. 7. A 7-7 profile line 802 represents the profile of the pixel wells 402, the walls 410, and the adjusted filled pixel wells 408′. Wall traces 804 of the 7-7 profile line 802 correspond with the walls 410. Similarly, ink traces 806 correspond with the adjusted ink 406′. Note that the ink traces 806 are more evenly distributed (e.g., the top surface has a dome shape) and generally drawn away from wall trace 804 of the 7-7 profile line 802. In this exemplary ink trace 806, the level of adjusted ink 406′ at the highest (thickest) point is approximately 1.6 micrometers. The level of adjusted ink 406′ at the lowest (thinnest) point is approximately 1.5 micrometers. Thus, difference between the lowest and highest points is approximately 0.1 micrometers. Such difference is significantly less than the difference of 0.3 micrometers depicted in FIG. 5.

FIG. 9 depicts a fourth exemplary profile graph 900 of the adjusted ink 406′ within one of the filled pixel wells 408 and the four pixel wells 402 taken as a cross-section along the 8-8 line 704. An 8-8 profile line 902 represents the profile of the pixel wells 402, the walls 410, and the filled pixel wells 408′. Wall traces 904 of the 8-8 profile line 902 correspond with the walls 410. Similarly, an ink trace 906 corresponds with the adjusted ink 406′. Note that the ink trace 906 is unevenly distributed (e.g., the top surface has a dome shape) and generally drawn away from wall trace 904 of the 8-8 profile line 902. Similar to third profile graph 800, the level of ink at the highest (thickest) point in the fourth profile graph 900 is approximately 1.6 micrometers. The level of the ink 406′ at the lowest (thinnest) point in the fourth profile graph 900 is approximately 1.4 micrometers. Thus, the difference between the highest and lowest point is approximately 0.2 micrometers. Such difference is less than the difference of 0.6 micrometers depicted in FIG. 6.

Thus, the image in FIG. 7 and the associated profile graphs of FIGS. 8 and 9, depict an example of the distribution of ink 406 as it may be disposed after being adjusted according to the systems and methods of the present invention.

Although the above exemplary matrix 400 depicts ink 406 with a domed (convex) profile, in some embodiments, the fill profile of pixel wells may be concave before the present invention is applied to adjust the profile. In such embodiments, the pressurized gas may be directed at an angle toward the side walls of the pixel wells and/or to the outer edges of the pixel wells to aid in adjusting the profile. Alternatively, a direct downward application of pressurized gas directed at the outer edges of the pixel wells or to the entirety of the pixel wells may be used to modify the profile. Alternatively, additional ink may be added to such partially filled ink wells.

While the present invention has been described primarily with reference to inkjet printing of color filters, it will be understood that the invention also may be employed with other materials and applications. For example, the present invention may also be applied to spacer formation, polarizer coating, and nanoparticle circuit forming.

Accordingly, while the present invention has been disclosed in connection with specific embodiments thereof, it should be understood that other embodiments may fall within the spirit and scope of the invention.

The invention claimed is:

1. A method of adjusting a pixel fill profile comprising:
applying pressurized gas to at least one pixel well having ink with a profile on a substrate having a plurality of pixel wells.

2. The method of claim 1 wherein applying pressurized gas to the at least one pixel well includes directing the pressurized gas to the ink.

3. The method of claim 2 wherein directing the pressurized gas to the ink includes directing more than one stream of gas to the ink.

4. The method of claim 1 wherein the ink profile is adjusted from an uneven shape to an approximately even shape.

5. The method of claim 4 wherein the uneven shape is an approximately convex shape.

6. The method of claim 4 wherein the uneven shape is an approximately concave shape.

7. The method of claim 1 further comprising depositing the ink into the at least one pixel well in a pass.

8. The method of claim 7 wherein applying pressurized gas and depositing ink into the pixel wells are performed in separate passes.

9. The method of claim 7 wherein applying pressurized gas and depositing ink into the pixel wells are performed in the same pass.

10. The method of claim 1 further comprising controlling the temperature of the ink.

11. The method of claim 1 further comprising controlling the temperature of the substrate.

12. The method of claim 1 further comprising controlling the temperature of the pressurized gas.

13. The method of claim 1 further comprising controlling the pressure of the pressurized gas.

14. The method of claim 13 wherein controlling the pressure includes controlling the pressure based on a position of the ink in the pixel well relative to the applied pressurized gas.

15. The method of claim 1 wherein applying pressurized gas to the pixel wells is performed at an angle less than ninety degrees relative to the top surface of the ink.

16. The method of claim 1 wherein applying pressurized gas to the at least one pixel well includes applying more than one stream of pressurized gas to the pixel well.

17. The method of claim 1 further comprising controlling the shape of the pressurized gas being directed to the pixel well.

18. The method of claim 1 further comprising applying a plurality of pressurized gases to a plurality of pixel wells with ink.

19. An apparatus for adjusting a pixel fill profile comprising:
a pressurized gas delivery system adapted to direct pressurized gas to at least one pixel well with ink in a substrate having a plurality of pixel wells to adjust a profile of the ink.

20. The apparatus of claim 19 further comprising a nozzle adapted to direct the pressurized gas.

21. The apparatus of claim 19 wherein the pressurized gas delivery system is further adapted to rotate.

22. The apparatus of claim 19 wherein the pressurized gas delivery system is further adapted to move.

23. The apparatus of claim 22 wherein the pressurized gas delivery system further includes a heater adapted to control the temperature of the pressurized gas.

24. A system for printing a color filter comprising:
an inkjet printing system adapted to hold a substrate having a plurality of pixel wells and deposit ink into at least one of the pixel wells; and
a gas delivery system coupled to the inkjet printing system and adapted to direct a pressurized gas to the at least one of the pixel wells.

25. The system of claim 24 wherein the inkjet printing system is further adapted to provide information related to the at least on of the pixel wells after being ink is deposited into the pixel well, and the gas delivery system is further adapted to receive the information.

26. The system of claim 25 wherein the gas delivery system is adapted direct the pressurized gas to the at least one of the pixel wells based on the information.

27. The system of claim 24 wherein the inkjet printing system further comprises inkjet print heads and a print bridge adapted to hold the inkjet print heads and wherein a portion of the gas delivery system is disposed on the print bridge.

28. The system of claim 27 wherein the portion of the gas delivery system is disposed on the print bridge proximate to the inkjet print heads.

29. The system of claim 24 wherein the inkjet printing system includes a heater adapted to heat the substrate.

30. The system of claim 24 further comprising a chamber adapted to surround the substrate and control the temperature of at least a portion of the substrate.

31. The system of claim 24 further comprising a chamber adapted to surround the inkjet printing system and control the temperature of at least a portion of the inkjet printing system.

32. The system of claim 24 further comprising a chamber adapted to surround the gas delivery system and adapted to control the temperature of at least a portion of the gas delivery system.

33. An apparatus for adjusting pixel fill profiles comprising:
a chamber adapted to:
support and contain a substrate having a plurality of pixels wherein at least one of the pixels is filled with ink with a profile; and
pressurize a gas surrounding the substrate to adjust the profile of the ink.

34. The apparatus of claim 33 wherein the chamber is further adapted to heat the substrate.

35. A method for adjusting pixel fill profiles comprising:
providing a substrate having a plurality of pixels wherein at least one of the pixels is filled with ink;
containing the substrate in a chamber having a gas that surrounds a portion of the substrate;
supporting the substrate in the chamber; and
increasing a pressure of the gas in the chamber to adjust the profile of the ink.

36. The method of claim 35 further comprising heating the substrate.
